(19) United States
(12) Patent Application Publication
(10) Pub. No.: US 2016/0187932 A1
(43) Pub. Date: Jun. 30, 2016

(54) HOUSING, ELECTRONIC DEVICE USING SAME, AND METHOD FOR MAKING SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHAO-HSUN LIN, New Taipei (TW); YI-TING YEH, New Taipei (TW); LI-HONG NA, Shenzhen (CN); YUAN-XIONG LIU, Shenzhen (CN)

(21) Appl. No.: 14/606,460

(22) Filed: Jan. 27, 2015

(30) Foreign Application Priority Data
Dec. 29, 2014 (CN) 201410832555.2

(51) Int. Cl. G06F 1/16

(52) U.S. Cl. CPC G06F 1/1656; G06F 1/1626; G06F 1/1662

(57) ABSTRACT

A housing includes a substrate defining a surface, and at least one seal ring formed on the substrate, the seal ring is made of elastic material, a surface of the seal ring connected with the substrate has a plurality of ribs, the surface of the substrate connecting with the seal ring has a plurality of holes, the ribs are engaged in the holes. A method of making a housing includes: a substrate defining a surface is provided; a plurality of holes is formed on the substrate; and at least one seal ring is formed on the substrate, the seal ring has a plurality of ribs, the ribs are engaged in the holes.

### FIELD

The subject matter herein generally relates to a housing, an electronic device using the housing, and a method for making the housing.

### BACKGROUND

Electronic devices such as mobile phones or personal digital assistants (PDAs) are widely used all over the world. If water leaks into the electronic devices, water causes electronic boards and electric circuits received in the electronic devices to corrode.

### BRIEF DESCRIPTION OF THE FIGURES

Implementations of the present technology will now be described, by way of example only, with reference to the attached figures.

FIG. 1 is an isometric view of an electronic device, according to an exemplary embodiment.

FIG. 2 is an exploded, isometric view of the electronic device shown in FIG. 1.

FIG. 3 is a cross-sectional view of the electronic device along line III-III of FIG. 1.

FIG. 4 is an enlarged, isometric view of the circled portion IV shown in FIG. 3.

FIG. 5 is an enlarged, isometric view of the circled portion V shown in FIG. 4.

FIG. 6 is a flow chart of a method for making a housing of the electronic device in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

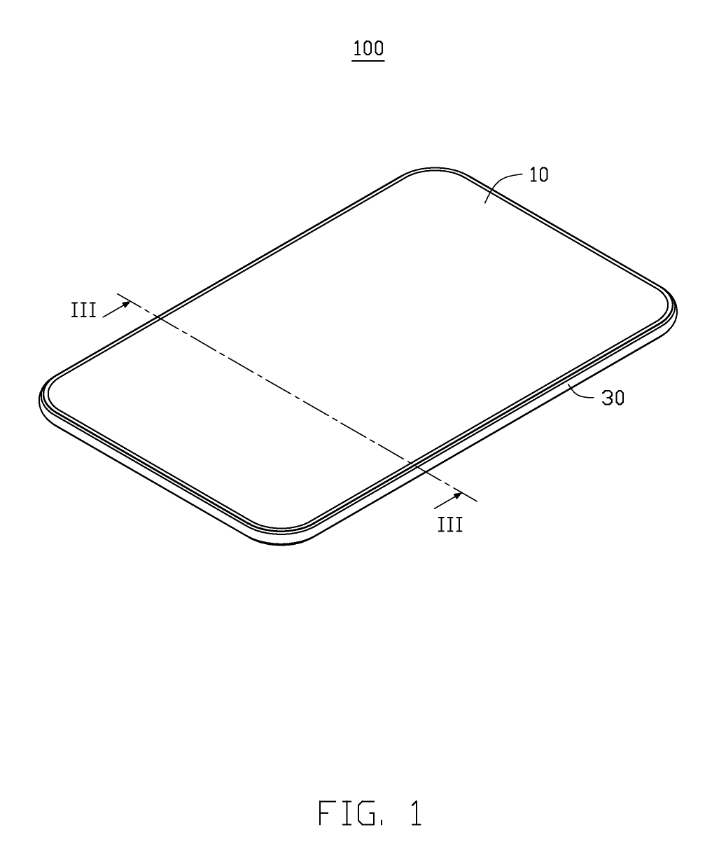

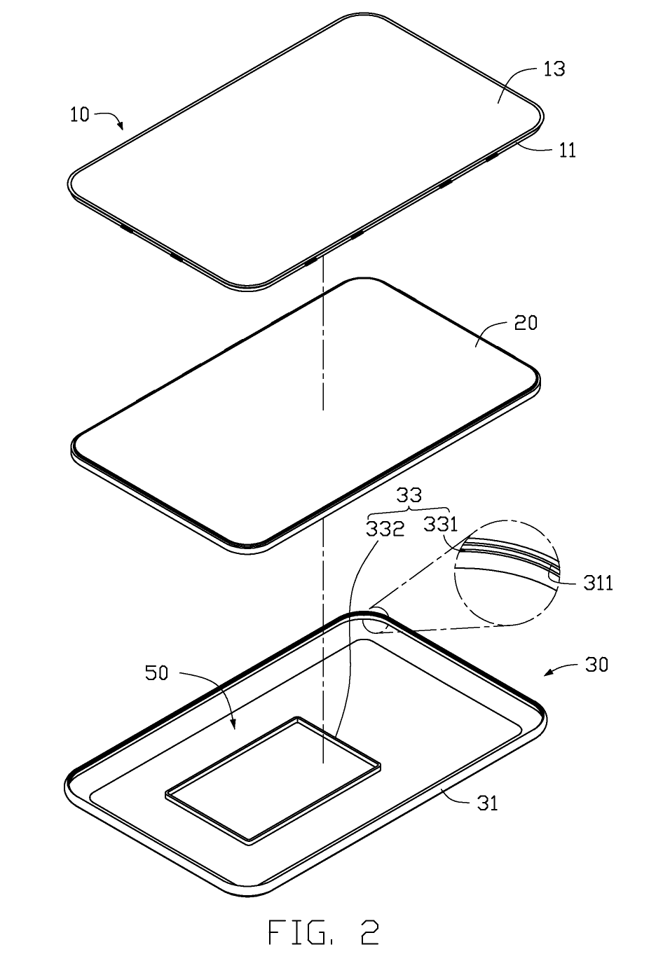

FIGS. 1-2 illustrate an electronic device 100 according to an exemplary embodiment. The electronic device 100 can be, but not limited to, a mobile phone, a personal digital assistant or a tablet computer. In an exemplary embodiment, the electronic device 100 is a mobile phone. The electronic device 100 includes a cover 10, a body 20 and a housing 30 assembled to the cover 10. The cover 10 and the housing 30 cooperatively form a cavity 50, the body 20 and elements (not shown) needed by the electronic device 100 can be received in the cavity 50.

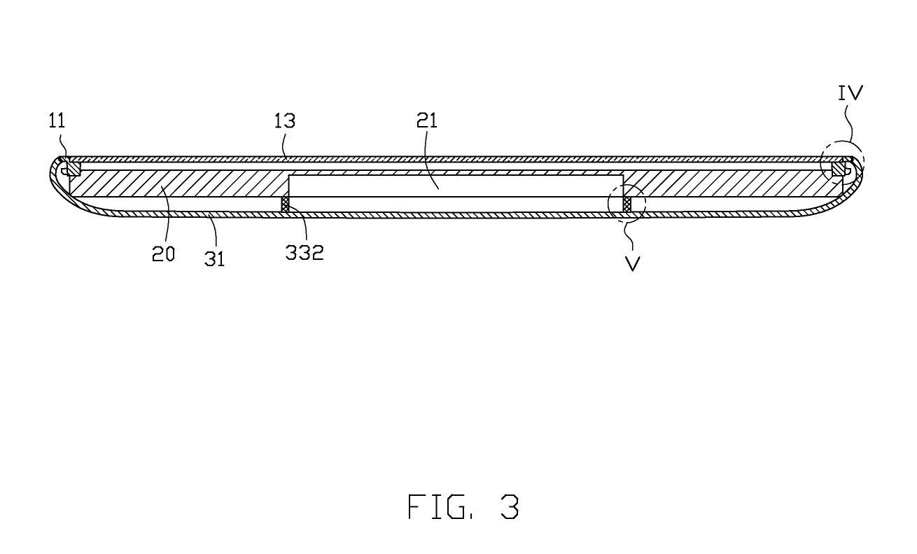

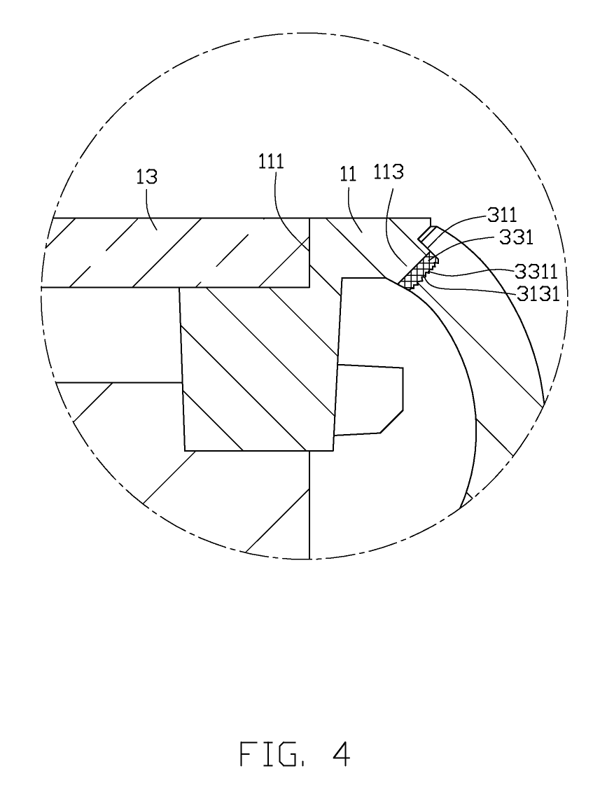

The cover 10 includes a top cover 11 and a display window 13 assembled to the top cover 11. FIGS. 3-4 illustrate that the top cover 11 has a notch 111 and a lug 113. The display window 13 is received in the notch 111. The lug 113 is formed on a circumference of the top cover 11 facing the cavity 50.

The body 20 includes a battery compartment 21 used for receiving a battery (not shown). The battery compartment 21 has a shape corresponding to the battery.

The housing 30 includes a substrate 31 and at least one seal ring 33 formed on an internal surface of the substrate 31. The seal ring 33 can interferingly fit to the cover 10, such that the cover 10 can be assembled to the housing 30 seamlessly.

The substrate 31 is made of a metal, such as stainless steel, aluminum, or aluminum alloy. The substrate 31 includes a groove 311, the groove 311 is formed on a circumference of the internal surface of the substrate 31. The lug 113 of the top cover 11 can be received in the groove 311, such that the cover 10 can be assembled to the housing 30.

The seal ring 33 can be made of an elastic material. The elastic material can be thermoplastic polyurethane (TPU). The seal ring 33 is waterproof and dustproof.

In at least one exemplary embodiment, the seal ring 33 includes a first seal ring 331 and a second seal ring 332. The first seal ring 331 is formed on a surface of the groove 311 connected with the lug 113, such that the housing 30 can be assembled to the cover 10 seamlessly. The second seal ring 332 is corresponding to the battery compartment 21, and has the same shape as the battery compartment 21. The second seal ring 332 has an area bigger than area of the battery compartment 21. The second seal ring 332 can elastically resist a circumference of the battery compartment 21, such that the housing 30 is waterproof and dustproof.

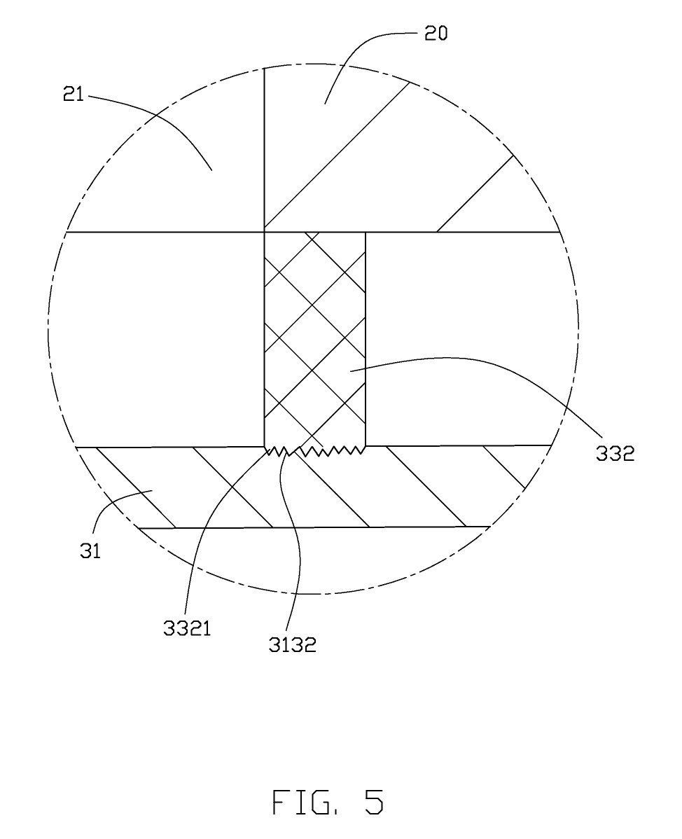

FIGS. 4-5 illustrate that portions of the substrate 31 connected with the first seal ring 331 have a plurality of holes 3131, another portions of the substrate 31 connected with the second seal ring 332 also have a plurality of holes 3132. In at least one exemplary embodiment, the holes 3131 are formed on a surface of the groove 311, the holes 3132 are formed on the internal surface of the substrate 31 connected with the second seal ring 332.

A surface of the first seal ring 331 connected with the substrate 31 has a plurality of ribs 3311, the ribs 3311 can be engaged in the holes 3131, a surface of the second seal ring 332 connected with the substrate 31 has a plurality of ribs 3321, the ribs 3321 can be engaged in the holes 3132, such that the seal rings 33 can be fixed on the substrate 31. The holes 3131, 3132 are nano holes, and have a diameter of about 30 nm to about 60 nm.

The electronic device 100 further includes keys (not shown) and a universal serial bus (USB, not shown). It is to be understood that circumferences of the keys and a circumference of the USB can have seal rings 33.

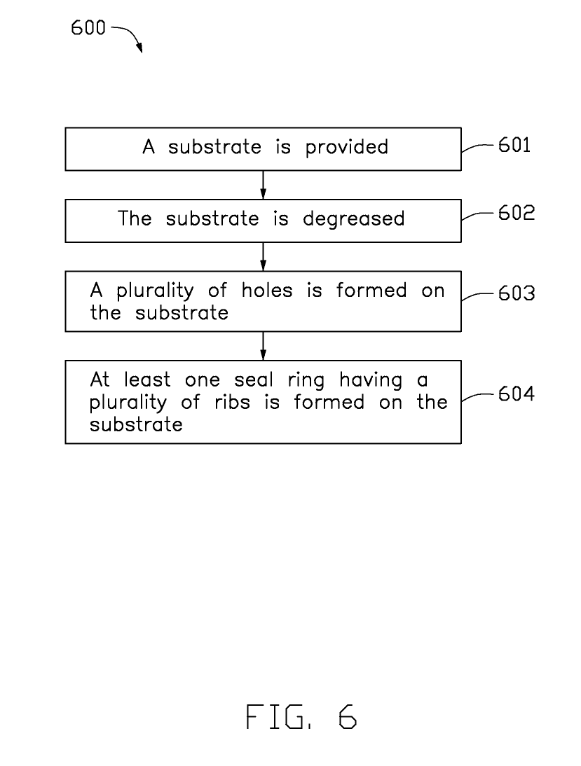

Referring to FIG. 6, a flowchart is presented in accordance with an example embodiment. The method 600 is provided by way of example, as there are a variety of ways to carry out the method. The method 600 described below can be carried out using the configurations illustrated in FIGS. 1-5, for example, and various elements of these figures are referenced in explaining example method 600. Each block shown in FIG. 6 represents one or more processes, methods or subroutines, carried out in the example method 600. Furthermore, the order of blocks is illustrative only and the order of the blocks can change according to the present disclosure. Additional blocks can be added or fewer blocks can be utilized, without departing from this disclosure. The method 600 for making the housing 30 can begin at block 601.

At block 601, a substrate 31 is provided. The substrate 31 has a groove 311, the groove 311 is formed on a circumference of an internal surface of the substrate 31. The substrate 31 is made of metal, such as stainless steel, aluminum, or aluminum alloy.

At block 602, the substrate 31 is degreased. Once degreased, the substrate 31 is rinsed with water.

At block 603, a plurality of holes 3131, 3132 is formed on the substrate 31. The holes 3131, 3132 can be formed by a nano mold technology (NMT), an electrochemical insert molding (ECIM), or an aluminum+plastic technology (ALPLAS). The holes 3131 are formed on a surface of the groove 311, the holes 3132 are formed on the internal surface of the substrate 31. The holes 3131, 3132 have a diameter of about 30 nm to about 60 nm.

At block 604, at least one seal ring 33 is formed on the substrate 31. In at least one exemplary embodiment, seal rings 331, 332 are formed on the substrate 31 by injecting elastic material on a surface of the groove 311 to form the first ring 331 and a portion of the substrate 31 corresponding to a battery compartment 21 to form the second seal ring 332, forming the housing 30. The first ring 331 has a plurality of ribs 3311 and the second seal ring 332 has a plurality of ribs 3321.

During the injection process, parts of the elastic material can also be filled into the holes 3131, 3132, forming the ribs 3311, 3321, such that the seal rings 33 can be fixed on the substrate 31.

A surface of the top cover 11 connected with the substrate 31 has a lug 113, the lug 113 can be received in the groove 311, and resists the first seal ring 331. The second seal ring 332 resist the circumference of the battery compartment 21, such that the cover 10 can interferingly fit to the housing 30, and the cover 10 can be assembled to the housing seamlessly, such that the electronic device 100 is waterproof and dustproof.

It is to be understood, however, that even through numerous characteristics and advantages of the present disclosure have been set forth in the foregoing description, together with details of assembly and function, the disclosure is illustrative only, and changes may be made in detail, including in the matters of shape, size, and arrangement of parts within the principles of the disclosure to the full extent indicated by the broad general meaning of the terms in which the appended claims are expressed.

What is claimed is:

1. A housing comprising:
a substrate defining a surface;
at least one seal ring being formed on the substrate, the seal ring being made of elastic material, a surface of the seal ring connected with the substrate having a plurality of ribs, the surface of the substrate connecting with the seal ring having a plurality of holes, the ribs being engaged in the holes.

2. The housing as claimed in claim 1, wherein the substrate is made of stainless steel, aluminum, or aluminum alloy.

3. The housing as claimed in claim 1, wherein the substrate includes a groove formed on a circumference of the surface of the substrate; the seal ring includes a first seal ring and a second seal ring, the first seal ring is formed on a surface of the groove, the second seal ring is formed on the surface of the substrate, and corresponding to a battery compartment.

4. The housing as claimed in claim 3, wherein portions of the substrate connected with the first seal ring have a plurality of holes, other portions of the substrate connected with the second seal ring also have a plurality of holes, the first seal ring and the second seal ring both have a plurality of ribs, the ribs formed on the first seal ring are engaged in the holes formed on the portions of the substrate connected with the first seal ring, the ribs formed on the second seal ring are engaged in the holes formed on the another portions of the substrate connected with the second seal ring.

5. The housing as claimed in claim 1, wherein the holes are nano holes.

6. The housing as claimed in claim 5, wherein the holes have a diameter of about 30 nm to about 60 nm.

7. The housing as claimed in claim 1, wherein the elastic material is thermoplastic polyurethane.

8. A method of making a housing comprising:
providing a substrate defining a surface;
forming a plurality of holes on the substrate; and
forming at least one seal ring on the substrate, the seal ring having a plurality of ribs, the ribs being engaged in the holes.

9. The method as claimed in claim 8, wherein the substrate includes a groove formed on a circumference of the surface of the substrate, the seal ring includes a first seal ring and a second seal ring, the first seal ring is formed on a surface of the groove through an injection process, the second seal ring is formed on the surface of the substrate, and corresponding to a battery compartment.

10. The method as claimed in claim 9, wherein portions of the substrate connected with the first seal ring form a plurality of holes, other portions of the substrate connected with the second seal ring also form a plurality of holes, the first seal ring and the second seal ring both have a plurality of ribs, the ribs formed on the first seal ring are engaged in the holes formed on the portions of the substrate connected with the first seal ring, the ribs formed on the second seal ring are engaged in the holes formed on the another portions of the substrate connected with the second seal ring.

11. An electronic device comprising:
a body;
a housing including:
a substrate defining a surface;
at least one seal ring being formed on the substrate, the seal ring being made of an elastic material, a surface of the seal ring connected with the substrate having a plurality of ribs, the surface of the substrate connecting with the seal ring having a plurality of holes, the ribs being engaged in the holes;
a cover; and
a seal ring interferingly fitting to the cover, such that the cover being assembled to the housing,
wherein the cover and the housing cooperatively form a cavity, the body being received in the cavity.

12. The electronic device as claimed in claim 11, wherein the substrate includes a groove formed on a circumference of the surface of the substrate, the cover includes a lug, the lug is received in the groove.

13. The electronic device as claimed in claim 12, wherein the base includes a battery compartment, the seal ring includes a first seal ring and a second seal ring, the first seal ring is formed on a surface of the groove connected with the lug, the second seal ring is formed on the surface of the substrate, and corresponding to the battery compartment.

14. The electronic device as claimed in claim 13, wherein the second seal ring has an area bigger than area of the battery compartment, and elastically resists a circumference of the battery compartment.

15. The electronic device as claimed in claim 13, wherein portions of the substrate connected with the first seal ring have a plurality of holes, other portions of the substrate connected with the second seal ring also have a plurality of holes, the first seal ring and the second seal ring both have a plurality of ribs, the ribs formed on the first seal ring are engaged in the holes formed on the portions of the substrate connected with the first seal ring, the ribs formed on the second seal ring are engaged in the holes formed on the another portions of the substrate connected with the second seal ring.

16. The electronic device as claimed in claim 11, wherein the electronic device further includes keys and a USB, circumferences of the keys and a circumference of the USB have seal rings.

17. The electronic device as claimed in claim 11, wherein the substrate is made of stainless steel, aluminum, or aluminum alloy.

18. The electronic device as claimed in claim 11, wherein the holes are nano holes, and have a diameter of about 30 nm to about 60 nm.

19. The electronic device as claimed in claim 11, wherein the elastic material is thermoplastic polyurethane.
